(19) United States
(12) Patent Application Publication
(10) Pub. No.: US 2001/0033603 A1
(43) Pub. Date: Oct. 25, 2001

(54) Spread spectrum burst signal receiver and related methods

(75) Inventor: David Allen Olaker, Melbourne, FL (US)

Correspondence Address: CHRISTOPHER F. REGAN, Allen, Dyer, Doppelt, Milbrath & Gilchrist, P.A., P.O. Box 3791, Orlando, FL, 32802-3791, US

(73) Assignee: Microgistics, Inc., Melbourne, FL (US)

(21) Appl. No.: 09/765,054

(22) Filed: Jan. 18, 2001

Related U.S. Application Data
(60) Provisional application No. 60/177,201, filed on Jan. 21, 2000.

(51) Int. Cl. H04K 1/00; H04B 15/00; H04L 27/30

(52) U.S. Cl. 375/143; 375/152

(57) ABSTRACT

A receiver for a spread spectrum burst signal having a predetermined period includes a time invariant matched filter for comparing an input signal to at least one reference signal based upon a pseudo-noise (PN) code and providing a stream of data values and a threshold comparator for comparing each of the stream of data values to a threshold to determine an acquisition time for the spread spectrum burst signal. The receiver may further include a contrast filter connected between the time invariant matched filter and the threshold comparator for varying the threshold based upon an interference level to reduce instances of false acquisition detections. Additionally, the receiver may include a window sampler for selectively sampling the data values based upon the acquisition time and the predetermined period.

### RELATED APPLICATION

The present application is based upon provisional application Ser. No. 60/177,201 filed Jan. 21, 2000, which is hereby incorporated herein in its entirety by reference.

### FIELD OF THE INVENTION

The present invention relates to the field of telecommunications, and, more particularly, to a spread spectrum communication receiver and related methods.

### BACKGROUND OF THE INVENTION

Spread spectrum communications systems are well known in the art. These systems differ from traditional radio systems, such as amplitude modulation (AM) and frequency modulation (FM) systems, in that the signal being transmitted is spread over a wide bandwidth rather than being centered around a particular carrier frequency. As a result, spread spectrum signals are less susceptible to either cause interference with or be affected by interference from such traditional radio transmissions.

Burst mode communication is another class of communications that is useful in a number of applications. A burst mode transmission involves sending data at a faster rate than normal for a limited period of time. One particular application where burst mode transmissions are beneficial is in wireless location devices. The low duty cycle, short duration transmission sequences allow for power conservation and higher system capacities through minimizing on air time.

Combining burst mode protocols with spread spectrum transmissions may provide even further reduction in interference with other signals. One example of a spread spectrum system which uses burst mode transmissions is provided in U.S. Pat. No. 5,717,713 to Natali entitled “Technique to Permit Rapid Acquisition and Alert Channel Signaling for Base Station-to-User Link of an Orthogonal CDMA (OCDMA) Communication System.” This patent discloses a spread spectrum receiver including amplifiers and in-phase (I) and quadrature (Q) mixers for down converting a received signal to a baseband. The signal is then routed to a digital matched filter. An output of the digital matched filter is monitored for correlation peaks that indicate signal presence. If the receiver is tuned to a proper frequency, an AC burst signal will be detected by a signal presence detector. Otherwise, the receiver keeps searching until the signal is detected.

While such a burst mode spread spectrum system may provide reduced interference with respect to many transmissions, it may still be susceptible to interference from other sources. These sources may include narrow band data communication systems such as frequency hopping wireless local area networks (LANs), for example. As a result, when interference from such a system is present, a spread spectrum receiver will be more susceptible to false acquisition detections of the spread spectrum burst signal.

### SUMMARY OF THE INVENTION

In view of the foregoing background, it is therefore an object of the invention to provide a receiver for a spread spectrum burst signal and related methods for reducing false acquisition detections of the spread spectrum burst signal.

This and other objects, features, and advantages in accordance with the present invention are provided by a receiver for a spread spectrum burst signal having a predetermined period including a time invariant matched filter for comparing an input signal to at least one reference signal based upon a pseudo-noise (PN) code and providing a stream of data values and a threshold comparator for comparing each of the stream of data values to a threshold to determine an acquisition time for the spread spectrum burst signal. The receiver may further include a contrast filter connected between the time invariant matched filter and the threshold comparator for varying the threshold based upon an interference level to reduce instances of false acquisition detections. Additionally, the receiver may include a window sampler for selectively sampling the data values based upon the acquisition time and the predetermined period.

More specifically, the contrast filter may subtract a weighted average of a current and previous data values from the current data value. The contrast filter may include a plurality of delay registers connected in series and each providing an output, and a summer for summing the outputs from the plurality of delay registers.

Additionally, the input signal may include in-phase (I) and quadrature (Q) values, and the time invariant matched filter may compare the I and Q values of the input signal to I and Q values of the at least one reference signal to provide a stream of I and Q data values. A magnitude converter may also be connected between the time invariant matched filter and the contrast filter for converting I and Q data values into a magnitude data value.

The receiver may further include a counter connected to the threshold comparator for generating an acquisition count based upon the acquisition time. Moreover, a window controller may be connected to the counter for generating a window strobe signal for controlling the window sampler. The receiver may also include a memory connected to the window sampler for storing the data values and a processor connected to the memory for processing the stored data values. More specifically, the memory may be a first-in first-out (FIFO) memory, and the processor may be a digital signal processor. The processor preferably performs non-real time processing of the stored data values.

Furthermore, the time invariant matched filter may continuously search over at least one of time, frequency, phase, and PN code alignments. The time invariant matched filter may include a discrete time, discrete amplitude device implementing a complex arithmetic cross correlation function. Further, the stream of data values may include a complex stream of data values based upon a degree and phase of correlation between the input signal and the at least one reference signal.

The receiver may further include a down converter upstream from the time invariant matched filter and a low noise amplifier upstream from the down converter. An analog-to-digital (A/D) converter may also be upstream from the time invariant matched filter.

A method aspect of the invention for receiving a spread spectrum burst signal having a predetermined period includes comparing an input signal to at least one reference signal based upon a PN code and providing a stream of data values, and comparing each of the stream of data values to a threshold to determine an acquisition time for the spread spectrum burst signal. The threshold may be varied based upon an interference level to reduce instances of false acquisition detections.

Another method aspect of the invention for receiving a spread spectrum burst signal having a predetermined period includes comparing an input signal to at least one reference signal based upon a PN code and a stream of data values and comparing each of the stream of data values to a threshold to determine an acquisition time for the spread spectrum burst signal. Furthermore, the data values may be selectively sampled based upon the acquisition time and the predetermined period.

Yet another method aspect of the invention for receiving a spread spectrum burst signal having a predetermined period includes comparing an input signal to at least one reference signal based upon a pseudo-noise (PN) code and providing a complex stream of data values based upon a degree and phase of correlation between the input signal and the at least one reference signal. Additionally, each of the data values is compared to a threshold to determine an acquisition time for the spread spectrum burst signal

### BRIEF DESCRIPTION OF THE DRAWINGS

FIG. 1 is a schematic block diagram of a receiver for a spread spectrum burst signal according to the present invention.

FIG. 2 is a more detailed schematic block diagram of the time invariant matched filter of FIG. 1.

FIG. 3 is a more detailed schematic block diagram of the magnitude converter of FIG. 1.

FIG. 4 is a more detailed schematic block diagram of the contrast filter of FIG. 1.

FIG. 5 is a more detailed schematic block diagram of the acquisition detector of FIG. 1.

FIG. 6 is a more detailed schematic block diagram of the window sampler of FIG. 1.

FIG. 7 is a more detailed schematic block diagram of the window controller of FIG. 1.

FIG. 8 is a more detailed schematic block diagram of the time tag counter of FIG. 1.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

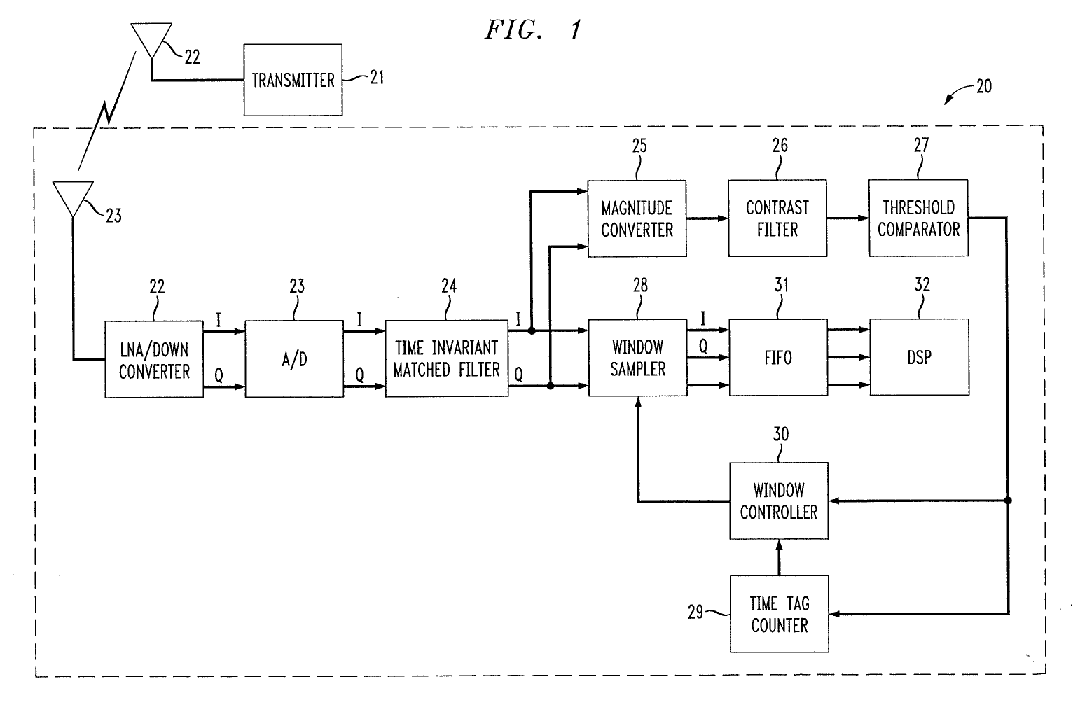

Referring now to the schematic block diagrams of FIGS. 1 to 8, a receiver 20 for a spread spectrum burst signal having a predetermined period in accordance with the present invention is now described. The receiver 20 may be used with a transmitter 21 which transmits a spread spectrum burst signal via an antenna 22. The transmitter 21 and receiver 20 are particularly well suited for wireless location devices, such as the WalkMate locator system manufactured by Microgistics, Inc. of Melbourne, Fla. The transmitter 21 and receiver 20 preferably operate using the direct sequence spread spectrum protocol, as will be understood by those of skill in the art. However, other spread spectrum protocols, such as frequency hopping, which are also known to those skilled in the art may also be used.

The receiver 20 includes an antenna 23 for receiving input signals. A low noise amplifier (LNA) and down converter 22 (illustratively shown as a single element for convenience) preferably covert the received input signal into analog in-phase (I) and quadrature (Q) values, for example, which may be done in a conventional manner known to those of skill in the art. Of course, it will also appreciate that other signal formats may be used in accordance with the present invention. The analog I and Q values are then converted into digital I and Q values by an analog-to-digital (A/D) converter 23.

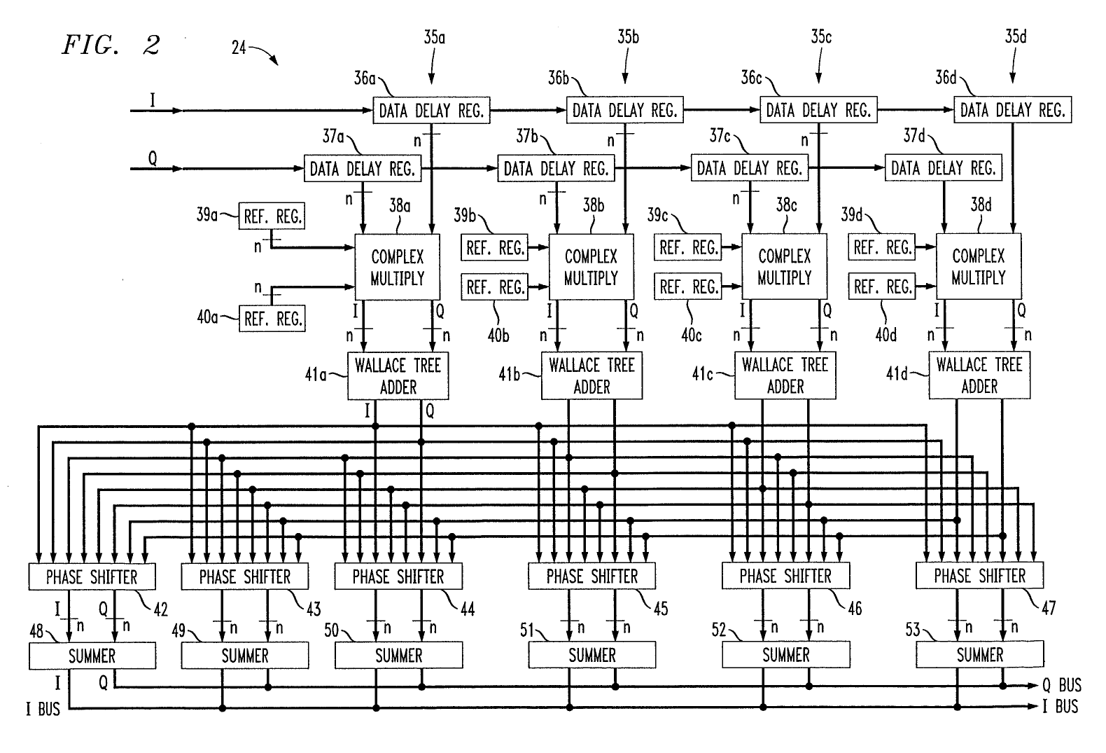

The A/D converter 23 and LNA/down converter 22 are upstream from a time invariant matched filter 24. The time invariant matched filter 24 compares the digital I and Q values of the input signal to I and Q values of at least one reference signal based upon a pseudo-noise (PN) code and provides a stream of I and Q data values. To this end, the time invariant matched filter 24 includes multiplication paths 35a-35d, as shown in FIG. 2. Each multiplication path includes a respective N bit data delay register 36a-36d, 37a-37d for the I and Q values being received from the A/D converter 23. The registers 36a-36d, 37a-37d may be serial registers, for example. While four multiplication paths 35a-35d are shown in FIG. 2, those skilled in the art will appreciate that other numbers of multiplication paths may be used depending upon the desired accuracy to be achieved.

Each multiplication path 35a-35d further includes a respective complex multiplier 38a-38d which multiplies respective outputs from the registers 36a-36d, 37a-37d with data stored in reference registers 39a-39d, 40a-40d corresponding to I and Q values of the at least one reference signal. I and Q outputs from the complex multipliers 38a-38d are input to respective Wallace tree adders 41a-41d. Furthermore, respective I and Q outputs from each of the Wallace tree adders 41 are input to phase shifters 42-47 corresponding to each respective multiplication path 35a-35d. Each phase shifter 42-47 shifts its respective inputs by different amounts depending upon a target frequency for each summer 48-53. The summers 48-53 sum respective outputs of the phase shifters 42-47 to provide a complex stream of I and Q data values based upon a degree and phase of correlation between the input signal and the at least one reference signal.

It will therefore be appreciated by those of skill in the art that the time invariant matched filter 24 is a discrete time, discrete amplitude device implementing a complex arithmetic cross correlation function. The time invariant matched filter 24 continuously searches over at least one of time, frequency, phase, and PN code alignments to provide for a substantially instantaneous acquisition of the spread spectrum burst signal. Thus, the time invariant matched filter 24 according to the present invention overcomes many of the difficulties associated with traditional acquisition and tracking loops of burst communication systems, as will also be appreciated by those of skill in the art.

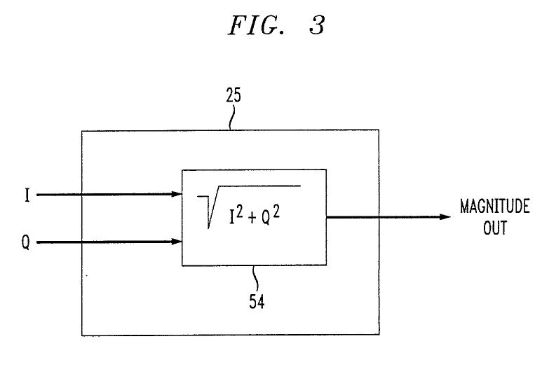

The receiver 20 further includes a magnitude converter 25 connected between the time invariant matched filter 24 and a contrast filter 26. The magnitude converter 25 converts the I and Q stream of data values from the time invariant matched filter 24 into a stream of magnitude data values. For example, the magnitude converter may be implemented using a circuit 54 which takes the square root of the sum of the squares of each pair of corresponding I and Q data values, as shown in FIG. 3.

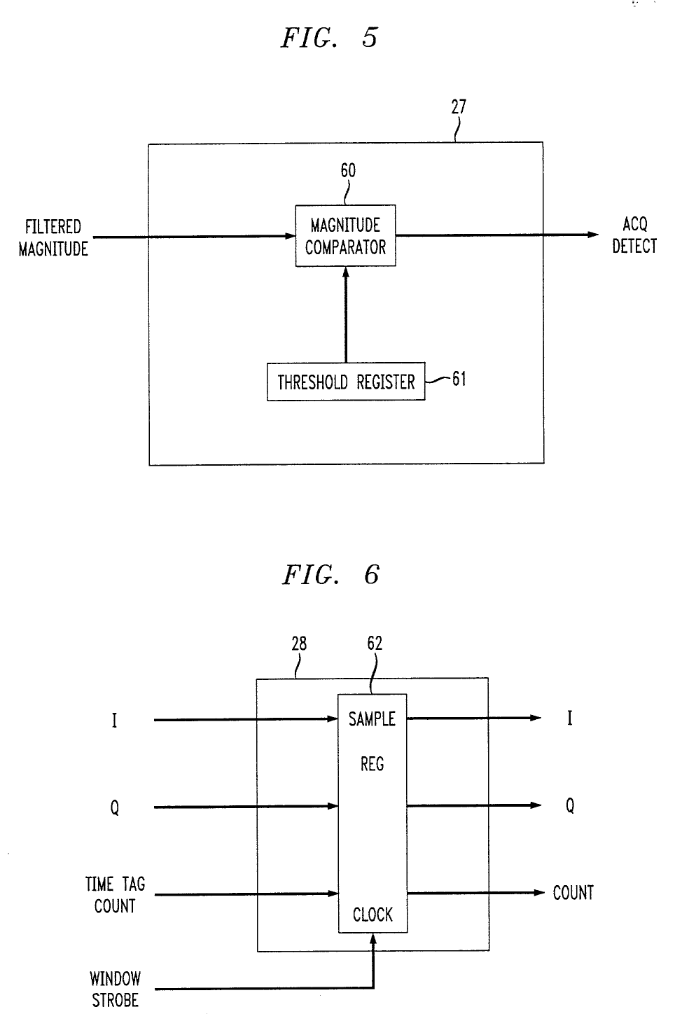

The contrast filter 26 is connected between the magnitude converter 25 and a threshold comparator 27. The threshold comparator 27 compares each of the magnitude data values to a threshold to determine an acquisition time for the spread spectrum burst signal. The threshold comparator 27 includes a magnitude comparator 60 for comparing filtered magnitude data values from the contrast filter 26 to the threshold, which is stored in a register 61, as shown in FIG. 5. An acquisition detect signal ACQ Detect is output by the threshold comparator 27 to indicate an acquisition detection of the spread spectrum burst signal.

Prior art acquisition tracking loops typically use a fixed or static threshold. Yet, if interfering signals or ambient noise is present then a probability of acquiring the spread spectrum burst signal is decreased. For example, such interference may cause a variation of the time invariant matched filter 24 gain, which would increase the chance of a false acquisition detection using prior art methods.

According to the present invention, the contrast filter 26 causes the threshold stored in the threshold register 61 to be varied based upon an interference level (e.g., ambient noise) to reduce instances of false acquisition detections. By using a varying or dynamic threshold that is adjusted based upon interference received by the receiver 20, the acquisition detector is less susceptible to interference from sources such as narrow band data communication systems that may otherwise cause a low probability of detection. Accordingly, the contrast filter 26 allows the acquisition detector 27 to more accurately detect acquisition of the spread spectrum burst signal.

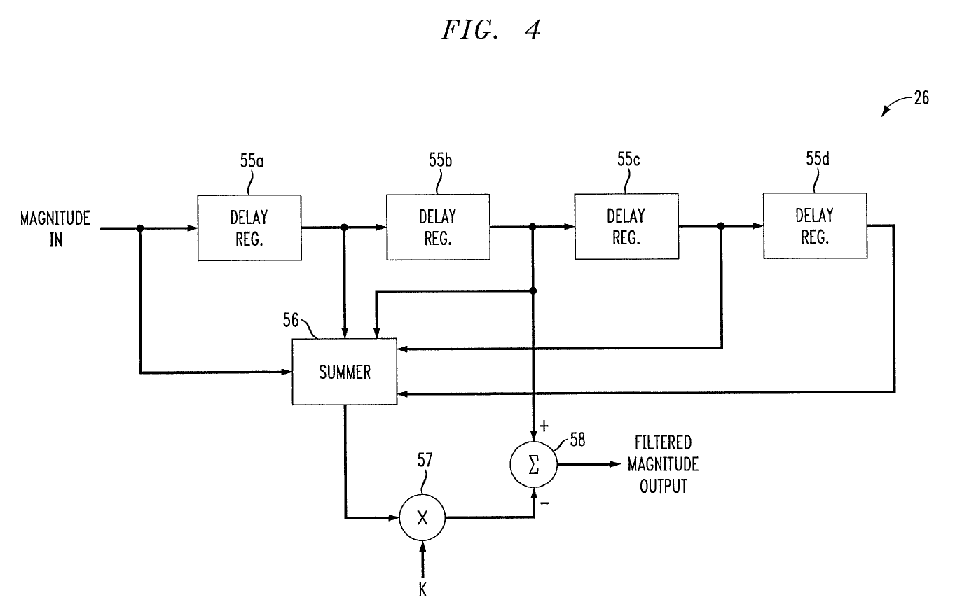

The contrast filter 26 includes delay registers 55a-55d connected in series which receive the magnitude data values from the magnitude converter 25 and each provide a respective output, as may be seen in FIG. 4. A summer 56 sums the outputs from the delay registers 55. An output of the summer 56 is connected to a multiplier 57 for multiplication with a constant K to provide a weighted average of a current and previous data values. A subtraction element 58 subtracts the weighted average from the current data value and provides filtered magnitude data values to the threshold comparator 27.

In addition to more accurately detecting acquisition of the spread spectrum burst signal, the present invention also provides for a significant reduction in processing following the acquisition. To this end, the receiver 20 includes a window sampler 28 for selectively sampling the data values received from the time invariant matched filter 24 based upon the acquisition time determined by the acquisition detector 27 and the predetermined period of the spread spectrum burst signal, which is known by the receiver. That is, once the acquisition time is determined by the acquisition detector 27, the timing of future data bursts can be determined using the acquisition time and the predetermined period.

As a result, only the data values corresponding to an expected time for each future data burst need to be processed and the rest may be discarded. Thus, by selectively sampling the data values corresponding to each data burst, the window sampler 28 provides a much smaller window of data values to be processed. As may be seen in FIG. 6, the window sampler includes a sample register 62 receiving as inputs the stream of I and Q data values from the time invariant matched filter 24, a Time Tag Count signal, and a Window Strobe signal on a clock input of the sample register.

The time tag counter 29 includes a counter 69, which may be a free running counter driven by a clock signal from a stable oscillator (not shown), for example, as shown in FIG. 8. A register 68 is connected to the counter 69 and receives as an input the ACQ Detect signal. Upon detection of an acquisition of the spread spectrum burst signal, the ACQ Detect signal causes a current count value from the counter 69 to be written on the register 68 and output as a signal ACQ Count.

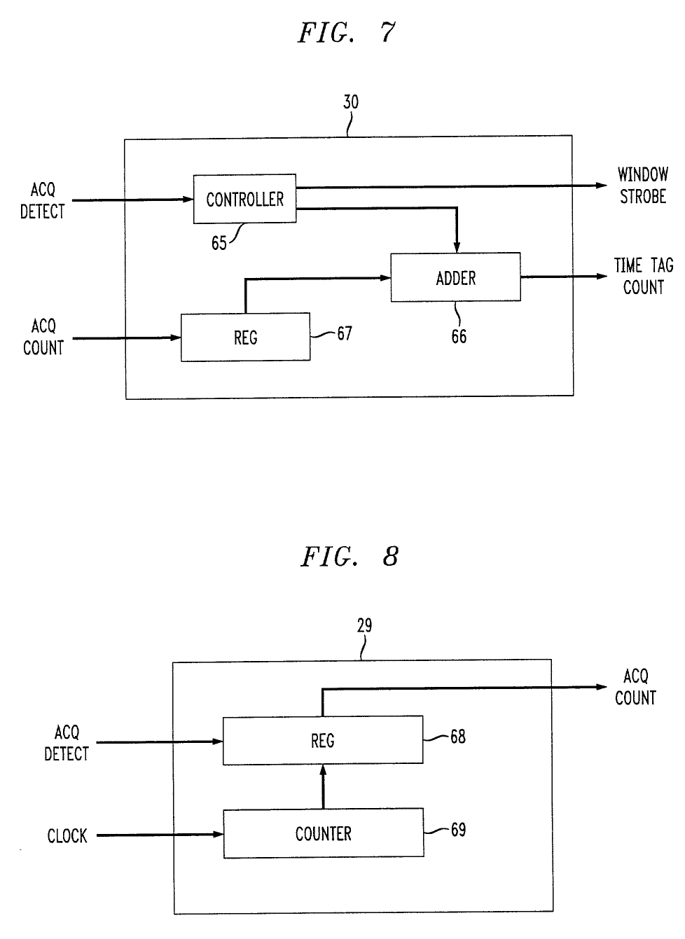

The ACQ Count signal is input to a register 27 of the window controller 30, as seen in FIG. 7. A controller 65 of the window controller 30 receives the ACQ Detect signal indicating an acquisition detection and generates the Window Strobe signal. The Window Strobe signal causes the window sampler 28 to store a window of data values for a short duration corresponding to an expected data burst. For example, the short duration may be a period corresponding to four data values before and after an expected data burst. In this way, slight timing drifts of the data burst will not cause the data burst to be outside of the window of data values. An adder connected to the controller 65 and the register 67 provides the Time Tag Count signal, which may be stored with the window of I and Q data values for later processing, as seen in FIG. 6.

Of course, by waiting until the ACQ Detect signal is received to generate the Window Strobe signal, at least one initial data value will not be included within the window of data values. However, a plurality of acquisition bursts are typically sent at the beginning of a data burst sequence, so this will likely not present a problem in many applications. Nonetheless, an additional memory could be included upstream from the window sampler 28 to store incoming data values so that the first acquisition burst may be included within each window if necessary, as will be appreciated by those of skill in the art.

A memory 31, such as a first-in first-out (FIFO) memory, is connected to the window sampler 28 for storing the window of data values. A separate window of data values may be stored for each symbol of an incoming message, for example, and the windows corresponding to a particular message may be stored as separate blocks. A processor 32 is connected to the memory 31 for processing the stored data values. The processor 32 may be an asynchronous processor, for example, such as a digital signal processor (DSP). Additionally, a plurality of DSPs may be used to improve throughput where each DSP processes a different message block, for example, as will be appreciated by those of skill in the art. It will also be appreciated that the processor 32 may advantageously perform non-real time processing of the stored data values.

Many of the above described elements, such as the time invariant matched filter 24, the magnitude converter 25, the contrast filter 26, and the window sampler 28, for example, have been represented as discrete elements for ease of illustration. However, those of skill in the art will appreciate that such elements may be implemented using software. Furthermore, the receiver 30 according to the present invention may be implemented using an application specific integrated circuit (ASIC), for example.

Additionally, many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and embodiments are intended to be included within the scope of the appended claims.

That which is claimed is:

1. A receiver for a spread spectrum burst signal having a predetermined period comprising:
a time invariant matched filter for comparing an input signal to at least one reference signal based upon a pseudo-noise (PN) code and providing a stream of data values;
a threshold comparator for comparing each of the data values to a threshold to determine an acquisition time for the spread spectrum burst signal;
a contrast filter connected between said time invariant matched filter and said threshold comparator for varying the threshold based upon an interference level to reduce instances of false acquisition detections; and
a window sampler for selectively sampling the data values based upon the acquisition time and the predetermined period.

2. The receiver of claim 1 wherein said contrast filter subtracts a weighted average of a current and previous data values from the current data value.

3. The receiver of claim 1 wherein said contrast filter comprises:
a plurality of delay registers connected in series and each providing an output; and
a summer for summing the outputs from said plurality of delay registers.

4. The receiver of claim 1 wherein said input signal comprises in-phase (I) and quadrature (Q) values; and wherein said time invariant matched filter compares the I and Q values of the input signal to I and Q values of the at least one reference signal and provides a stream of I and Q data values.

5. The receiver of claim 4 further comprising a magnitude converter connected between said time invariant matched filter and said contrast filter for converting I and Q data values into a magnitude data value.

6. The receiver of claim 1 further comprising a counter connected to said threshold comparator for generating an acquisition count based upon the acquisition time.

7. The receiver of claim 6 further comprising a window controller connected to said counter and generating a window strobe signal for controlling said window sampler.

8. The receiver of claim 1 further comprising:
a memory connected to s aid window sampler for storing the data values; and
a processor connected to said memory for processing the stored data values.

9. The receiver of claim 8 wherein said processor performs non-real time processing of the stored data values.

10. The receiver of claim 1 wherein the stream of data values comprises a complex stream of data values based upon a degree and phase of correlation between the input signal and the at least one reference signal.

11. The receiver of claim 1 wherein said time invariant matched filter continuously searches over at least one of time, frequency, phase, and PN code alignments.

12. The receiver of claim 1 wherein said time invariant matched filter comprises a discrete time, discrete amplitude device implementing a complex arithmetic cross correlation function.

13. The receiver of claim 1 further comprising a down converter upstream from said time invariant matched filter.

14. The receiver of claim 13 further comprising a low noise amplifier upstream from said down converter.

15. The receiver of claim 1 further comprising an analog-to-digital (A/D) converter upstream from said time invariant matched filter.

16. A receiver for a spread spectrum burst signal having a predetermined period comprising:
a time invariant matched filter for comparing an input signal to at least one reference signal based upon a pseudo-noise (PN) code and providing a stream of data values;
a threshold comparator for comparing each of the data values to a threshold to determine an acquisition time for the spread spectrum burst signal; and
a contrast filter connected between said time invariant matched filter and said threshold comparator for varying the threshold based upon an interference level to reduce instances of false acquisition detections.

17. The receiver of claim 16 wherein said contrast filter subtracts a weighted average of a current and previous data values from the current data value.

18. The receiver of claim 16 wherein said contrast filter comprises:
a plurality of delay registers connected in series and each providing an output; and
a summer for summing the outputs from said plurality of delay registers.

19. The receiver of claim 16 wherein said input signal comprises in-phase (I) and quadrature (Q) values; and wherein said time invariant matched filter compares the I and Q values of the input signal to I and Q values of the at least one reference signal and provides a stream of I and Q data values.

20. The receiver of claim 19 further comprising a magnitude converter connected between said time invariant matched filter and said contrast filter for converting I and Q data values into a magnitude data value.

21. The receiver of claim 16 wherein said time invariant matched filter continuously searches over at least one of time, frequency, phase, and PN code alignments.

22. A receiver for a spread spectrum burst signal having a predetermined period comprising:
a time invariant matched filter for comparing an input signal to at least one reference signal based upon a pseudo-noise (PN) code and providing a stream of data values;
a threshold comparator for comparing each of the data values to a threshold to determine an acquisition time for the spread spectrum burst signal; and
a window sampler for selectively sampling the data values based upon the acquisition time and the predetermined period.

23. The receiver of claim 22 further comprising a counter connected to said threshold comparator for generating an acquisition count based upon the acquisition time.

24. The receiver of claim 23 further comprising a window controller connected to said counter and generating a window strobe signal for controlling said window sampler.

25. The receiver of claim 22 further comprising:
a memory connected to said window sampler for storing the data values; and
a processor connected to said memory for processing the stored data values.

26. The receiver of claim 25 wherein said processor performs non-real time processing of the stored data values.

27. The receiver of claim 22 wherein said time invariant matched filter continuously searches over at least one of time, frequency, phase, and PN code alignments.

28. A receiver for a spread spectrum burst signal having a predetermined period comprising:
a time invariant matched filter for comparing an input signal to at least one reference signal based upon a pseudo-noise (PN) code and providing a complex stream of data values based upon a degree and phase of correlation between the input signal and the at least one reference signal; and
a threshold comparator for comparing each of the data values to a threshold to determine an acquisition time for the spread spectrum burst signal.

29. The receiver of claim 28 wherein said input signal comprises in-phase (I) and quadrature (Q) values; and wherein said time invariant matched filter compares the I and Q values of the input signal to I and Q values of the at least one reference signal and provides a complex stream of I and Q data values.

30. The receiver of claim 28 wherein said time invariant matched filter continuously searches over at least one of time, frequency, phase, and PN code alignments.

31. The receiver of claim 28 wherein said time invariant matched filter comprises a discrete time, discrete amplitude device implementing a complex arithmetic cross correlation function.

32. A method for receiving a spread spectrum burst signal having a predetermined period comprising:
comparing an input signal to at least one reference signal based upon a pseudo-noise (PN) code and providing a stream of data values;
comparing each of the stream of data values to a threshold to determine an acquisition time for the spread spectrum burst signal; and
varying the threshold based upon an interference level to reduce instances of false acquisition detections.

33. The method of claim 32 wherein varying comprises subtracting a weighted average of a current and previous data values from a current data value.

34. The method of claim 32 wherein the input signal comprises in-phase (I) and quadrature (Q) values; and wherein comparing the input signal to the at least one reference signal comprises comparing the I and Q values of the input signal to I and Q values of the at least one reference signal and providing a stream of I and Q data values.

35. The method of claim 34 further comprising converting I and Q data values into a magnitude data value.

36. The method of claim 32 wherein comparing the input signal to the at least one reference signal comprises continuously searching over at least one of time, frequency, phase, and PN code alignments.

37. A method for receiving a spread spectrum burst signal having a predetermined period comprising:
comparing an input signal to at least one reference signal based upon a pseudo-noise (PN) code and providing a stream of data values;
comparing each of the stream of data values to a threshold to determine an acquisition time for the spread spectrum burst signal; and
selectively sampling the data values based upon the acquisition time and the predetermined period.

38. The method of claim 37 further comprising generating an acquisition count based upon the acquisition time.

39. The method of claim 37 further comprising storing the data values and processing the stored data values.

40. The method of claim 39 wherein processing comprises processing the stored data values in non-real time.

41. The method of claim 37 wherein comparing the input signal to the at least one reference signal comprises continuously searching over at least one of time, frequency, phase, and PN code alignments.

42. A method for receiving a spread spectrum burst signal having a predetermined period comprising:
comparing an input signal to at least one reference signal based upon a pseudo-noise (PN) code;
providing a complex stream of data values based upon a degree and phase of correlation between the input signal and the at least one reference signal; and
comparing each of the data values to a threshold to determine an acquisition time for the spread spectrum burst signal.

43. The method of claim 42 wherein said input signal comprises in-phase (I) and quadrature (Q) values; wherein comparing the input signal to the at least one reference signal comprises comparing the I and Q values of the input signal to I and Q values of the at least one reference signal; and wherein providing comprises providing a complex stream of I and Q data values.

44. The method of claim 42 wherein comparing the input signal to the at least one reference signal comprises continuously searching over at least one of time, frequency, phase, and PN code alignments.
